(19) United States
(12) Patent Application Publication
(10) Pub. No.: US 2010/0272899 A1
(43) Pub. Date: Oct. 28, 2010

(54) METHOD FOR PRINTING ON HOUSINGS

(75) Inventors: JIANG-RONG DING, Shenzhen City (CN); JI-KAI LIU, Shenzhen City (CN); ZI-FEI MENG, Shenzhen City (CN); CHA-SONG XIE, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/627,041

(22) Filed: Nov. 30, 2009

(30) Foreign Application Priority Data
Apr. 23, 2009 (CN) 200910301787.4

(51) Int. Cl. B05D 1/38

(52) U.S. Cl. 427/265

(57) ABSTRACT

A printing method comprises: providing a metal housing; printing a first ink coating on the metal housing and drying the first ink coating at a temperature of about 100-150° C. for about 15-25 minutes, the first ink coating including epoxy resin; printing a second ink coating on the first ink coating and drying the second ink coating at a temperature of about 100-150° C. for about 15-25 minutes, the second ink coating including epoxy resin; and printing a third ink coating on the second ink coating and drying the third ink coating at a temperature of about 100-150° C. for about 60-120 minutes, the third ink coating including epoxy resin.

### BACKGROUND

1. Technical Field

The present disclosure relates to printing methods, especially to a printing method for printing high abrasion resistance layer or coating on housings.

2. Description of Related Art

Housings of portable electronic devices are commonly decorated using silk-screen printing. However, general silk-screen printings have poor abrasion resistance.

Therefore, there is room for improvement within the art.

### DETAILED DESCRIPTION

A printing method may comprise the following steps: providing a metal housing; printing a first ink coating on the metal housing and drying the first ink coating at a temperature of about 100-150° C. for about 15-25 minutes, the first ink coating including epoxy resin; printing a second ink coating on the first ink coating and drying the second ink coating at a temperature of about 100-150° C. for about 15-25 minutes, the second ink coating including epoxy resin; printing a third ink coating on the second ink coating and drying the third ink coating at a temperature of about 100-150° C. for about 60-120 minutes, the third ink coating including epoxy resin. Each step is described in more detail below.

A metal housing is provided. The metal housing is made of aluminum or aluminum alloy. The metal housing can be anodized to form an anode oxide film thereon.

A first ink coating is formed on the metal housing or the anode oxide film formed on the metal housing by silk-screen printing. The first ink coating may be decorative and/or protective. The ink used for printing the first ink coating contains a first major agent(s), a second major agent(s), a firming agent(s), and a diluting agent(s).

The first major agent(s) may contain an epoxy resin component in a mass percent of about 35-40% of the first major agent(s), a pigment component in a mass percent of about 25-40% of the first major agent(s), and a solvent component. The solvent may contain a glycol monomer component in a mass percent of about 12-18% of the solvent, an aromatic hydrocarbon solvent component in a mass percent of about 4-6% of the solvent, and a cyclohexanone component in a mass percent of about 4-6% of the solvent. The first major agent(s) may further contain an additive agent in a mass percent of about 4-7% of the first major agent(s).

The second major agent(s) may be a transparent varnish. The second major agent(s) may contain epoxy resin in a mass percent of about 60-80% of the second major agent(s) and solvent component. The solvent may contain a glycol monomer component in a mass percent of about 12-18% of the solvent, an aromatic hydrocarbon solvent component in a mass percent of about 4-6% of the solvent, and a cyclohexanone component in a mass percent of about 4-6% of the solvent. The second major agent(s) may further contain a brightener component in a mass percent of about 4-7% and an additive agent. The second major agent(s) may be chosen to have high rigidity and good abrasion resistance, which can improve the abrasion resisting ability of the first ink coating.

The firming agent(s) may contain a polyamide resin component in a mass percent of about 55-65% of the firming agent(s) and a solvent component. The solvent may contain a glycol monomer component in a mass percent of about 18-24% of the solvent, an aromatic hydrocarbon solvent component in a mass percent of about 6-8% of the solvent, and a cyclohexanone component in a mass percent of about 6-8% of the solvent. The firming agent(s) may further contain an assistant agent in a mass percent of about 4-7% of the firming agent(s), such as silicone.

The diluting agent(s) can be solvent containing a glycol monomer component in a mass percent of about 55-65% of the solvent, an aromatic hydrocarbon solvent component in a mass percent of about 15-25% of the solvent, and a cyclohexanone component in a mass percent of about 15-25% of the solvent.

The ink used for printing the first ink coating may be made by blending the first major agent(s) and the firming agent(s) at a mass ratio of about 7:3 to obtain a first middle ink first; then employing the second major agent(s) into the first middle ink to obtain a mixed ink, the second major agent(s) is in a mass percent of about 30% of the mixed ink; and at last, employing the diluting agent(s) into the mixed ink to obtain the ink used for printing the first ink coating, the diluting agent(s) is in a mass percent of about 2-8% of the mixed ink. The mass ratio among the first major agent(s), the second major agent(s), the firming agent(s) and the diluting agent(s) is about 49:30:21:2-8.

After being printed, the first ink coating is dried at a temperature of about 100-150° C. for about 15-25 minutes, preferably, dried at a temperature of 118-122° C. for about 20 minutes.

A second ink coating is formed on the first ink coating by silk-screen printing. The ink used for printing the second ink coating contains a second major agent(s), a firming agent(s), and a diluting agent(s). The firming agent(s) and the diluting agent(s) are the same types of firming agent(s) and diluting agent(s) used in the first ink coating.

The ink used for printing the second ink coating may be made by blending the second major agent(s) and the firming agent(s) at a mass ratio of about 7:3 to obtain a second middle ink first; then employing the diluting agent(s) into the second middle ink to obtain the ink used for printing the second ink coating, the diluting agent(s) is in a mass percent of about 2-8% of the second middle ink. The mass ratio among the second major agent(s), the firming agent(s) and the diluting agent(s) is about 35:15:1-4.

After being printed, the second ink coating is dried at a temperature of about 100-150° C. for about 15-25 minutes, preferably, dried at a temperature of 118-122° C. for 20 minutes to obtain a solidified second ink coating. The solidified second ink coating has a good abrasion resistance for the second major agent(s) has high rigidity and good abrasion resistance. During the drying process, the resin component contained in the second ink coating can cross-linking react with the resin component in the first ink coating to obtain a cross-linking structure between the second ink coating and the first ink coating, which can improve the bonding of the second ink coating to the first ink coating and can further improve the abrasion resistance of the second ink coating.

A third ink coating is formed on the second ink coating by silk-screen printing. The ink used for printing the third ink coating is the same type of the ink used for printing the second ink coating. The third ink coating should be dried to improve the bonding of the third ink coating to the second ink coating, and at the same time, to improve the abrasion resistance of the third ink coating. The temperature of drying the third ink coating is about 100-150° C., preferably, 118-122° C. The drying process should be last for about 60-120 minutes, preferably, 65-75 minutes.

Printing formed on a housing via the above method has undergone an abrasion resistance test. The test was carried out by applying fifty abrasion cycles to the housing under a load of 16.1±0.05N. In the test, no cracking, and no abrading of the printing, i.e., the third ink coating, the second ink coating, and the first ink coating were observed.

The present disclosure uses an ink made using a specific recipe to form printing on a housing using a specific technique under specific drying conditions, which greatly improves the abrasion resistance of the printing.

It is believed that the present embodiment and its advantages will be understood from the foregoing description, and it will be apparent that various changes may be made thereto without departing from the spirit and scope of the disclosure or sacrificing all of its advantages, the examples hereinbefore described merely being preferred or exemplary embodiment of the disclosure.

What is claimed is:

1. A printing method, comprising:
providing a metal housing;
printing a first ink coating on the metal housing and drying the first ink coating at a temperature of about 100-150° C. for about 15-25 minutes, the first ink coating including epoxy resin;
printing a second ink coating on the first ink coating and drying the second ink coating at a temperature of about 100-150° C. for about 15-25 minutes, the second ink coating including epoxy resin; and
printing a third ink coating on the second ink coating and drying the third ink coating at a temperature of about 100-150° C. for about 60-120 minutes, the third ink coating including epoxy resin.

2. The method as claimed in claim 1, wherein the metal housing is made of aluminum or aluminum alloy.

3. The method as claimed in claim 1, wherein the metal housing is formed with an anode oxide film thereon.

4. The method as claimed in claim 1, wherein drying the first ink coating is carried out at a temperature of about 118-122° C. for about 20 minutes; drying the second ink coating is carried out at a temperature of about 118-122° C. for about 20 minutes; drying the third ink coating is carried out at a temperature of about 118-122° C. for about 65-75 minutes.

5. The method as claimed in claim 1, wherein printing the first ink coating is carried out by using an ink that contains a first major agent(s), a second major agent(s), a firming agent(s), and a diluting agent(s); the ink is made by blending the first major agent(s) and the firming agent(s) at a mass ratio of about 7:3 to obtain a first middle ink; then mixing the second major agent(s) into the first middle ink to obtain a mixed ink, the second major agent(s) is in a mass percent of about 30% of the mixed ink; and at last, employing the diluting agent(s) into the mixed ink, the diluting agent(s) is in a mass percent of about 2-8% of the mixed ink.

6. The method as claimed in claim 5, wherein the first major agent(s) contains an epoxy component in a mass percent of about 35-40% of the first major agent(s).

7. The method as claimed in claim 5, wherein the second major agent(s) is a transparent varnish; the second major agent(s) contains an epoxy component in a mass percent of about 60-80% of the second major agent(s).

8. The method as claimed in claim 5, wherein the firming agent(s) contains a polyamide resin component in a mass percent of about 55-65% of the firming agent(s).

9. The method as claimed in claim 5, wherein printing the second ink coating is carried out by using an ink that contains a second major agent(s), a firming agent(s), and a diluting agent(s); the ink used for printing the second ink coating is made by blending the second major agent(s) and the firming agent(s) at a mass ratio of about 7:3 to obtain a second middle ink first; then employing the diluting agent(s) into the second middle ink, the diluting agent(s) is in a mass percent of about 2-8% of the second middle ink.

10. The method as claimed in claim 9, wherein printing the third ink coating is carried out by using the same type of ink used in forming the second ink coating.

11. A printing method, comprising:
providing a metal housing;
printing a first ink coating on the metal housing and drying the first ink coating at a temperature of about 100-150° C. for about 15-25 minutes, the first ink coating including epoxy resin; and
printing a second ink coating on the first ink coating and drying the second ink coating at a temperature of about 100-150° C. for about 15-25 minutes, the second ink coating including epoxy resin.
